(19) United States
(12) Patent Application Publication
(10) Pub. No.: US 2014/0075322 A1
(43) Pub. Date: Mar. 13, 2014

(54) Web Application Server Architecture With Embedded Scripting Language And Shell Services

(71) Applicant: Paul Delano, Westport, CT (US)

(72) Inventor: Paul Delano, Westport, CT (US)

(21) Appl. No.: 14/023,145

(22) Filed: Sep. 10, 2013

Related U.S. Application Data
(60) Provisional application No. 61/699,641, filed on Sep. 11, 2012.

(51) Int. Cl. H04L 12/24

(52) U.S. Cl. CPC H04L 41/22
USPC 715/736

(57) ABSTRACT

A web application server architecture has an interactive scripting language, development environment and operating-system-like services embedded. The architecture includes a server engine installed in an operating system of a computing device, and a server shell installed in the server engine. The server shell includes a resource management layer for configuring and naming resources and providing an interface to the resources; a shell services layer for providing application script development tools, a scripting language layer providing a programming language for creating web applications and for accessing external data, and a components layer for providing predefined functionality. The architecture also includes a user interface for developing and controlling an application, including a command prompt section for receiving a command entered by a user; a resource explorer section for facilitating viewing, searching, and operating on the resources; and an editing section for facilitating editing of data.

### FIELD OF THE INVENTION

The present teachings relate generally to networked services and, more particularly, to web application servers and server architectures.

### BACKGROUND OF THE INVENTION

Web application servers are the backbone of the Internet. They run 24×7, serving web pages, audio, video, interactive applications (e.g., office productivity, CRM, search engines, etc.), social media (e.g., Twitter, LinkedIn, Facebook, etc.), commercial enterprises (e.g., eCommerce, etc.), and content for web or other clients. Web application servers comprise system software upon which web applications run and execute procedures (e.g., programs, routines, scripts). They utilize computer programming languages, runtime libraries, database connectors, and the administration code needed to deploy, configure, manage, and connect these components on a web host. Components are typically performed in the same running environment as the web server, and their main job is to support the construction of dynamic pages (e.g., dynamic HTML, etc.) or other structured or unstructured data in any number of formats (e.g., XML, etc.).

Typical web application server architecture is shown schematically in FIG. 1. This architecture includes server based applications 101 that are built with scripts 102 and scripted pages 103 using programming languages (e.g., Java 104, PHP 105, Perl 106, etc.). Applications written in programming languages run inside a server engine 120 installed in an operating system 130 (e.g., Linux®, Windows®, etc.). In addition to scripts 102 and scripted pages 103, applications 101 typically also include static content 110. Applications 101 also access resources such as databases 141, file systems 142, or other networked services 143 through facilities provided by the operating system 130. Clients 100 interact with the server based applications 101, often using a web browser.

However, known web server architecture suffers from a number of failings, including that it requires the remote installation of software (e.g., development environment on a client computer, server admin services that depend on the operating system and have security issues, etc.) to create web applications. There is a need for a web application server architecture in which web application development and deployment is faster, easier and more secure. Therefore, it would be beneficial to have a superior system and method for a web application server architecture with embedded scripting language and shell services.

### SUMMARY OF THE INVENTION

The needs set forth herein as well as further and other needs and advantages are addressed by the present embodiments, which illustrate solutions and advantages described below.

The system of the present embodiment includes, but is not limited to, a web server having an operating system and a server engine, at least one server based application executing on the web server and using the server engine, and an interface having a graphical user interface (e.g., interactive, etc.) receiving at least one command. The system also has a server shell executing on the web server, the server shell receiving the at least one command from the interface, sending the at least one command to the at least one server application, receiving at least one response from the at least one server application in response to the at least one command, and sending the at least one response to the interface, the interface displaying the at least one response.

In another embodiment, the system of the present embodiment includes, but is not limited to, a web server having an operating system and a server engine, at least one server based application executing on the web server and using the server engine, and an interface having a graphical user interface (e.g., interactive, etc.) receiving at least one command. The system also has a server shell executing on the web server, the server shell receiving the at least one command from the interface, sending the at least one command to the at least one server application, receiving at least one response from the at least one server application in response to the at least one command, and sending the at least one response to the interface, the interface displaying the at least one response. The server shell comprises an editor provided through the interface and adapted to edit and create files on the server. The server shell provides interactive script execution. The interface comprises at least one web page. The interface in another embodiment may comprise a mobile application.

The method of the present embodiment includes the steps of, but is not limited to, providing a web server having an operating system, a server engine, and at least one server based application using the server engine; providing an interface having a graphical user interface (e.g., interactive, etc.); receiving, with the interface, at least one command; providing a server shell executing on the web server; receiving, with the server shell, the at least one command from the interface; sending, with the server shell, the at least one command to the at least one server application; receiving, with the server shell, at least one response from the at least one server application in response to the at least one command; sending, with the server shell, the at least one response to the interface; and displaying the at least one response through the interface. The server shell provides interactive script execution.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic illustration of a typical web server architecture in the prior art.

FIG. 2 is a schematic illustration of one embodiment of a web server architecture according to the present teachings.

FIG. 3A is a flowchart schematically illustrating a process flow for executing a web application in response to a client request using the server architecture of FIG. 1.

FIG. 3B is a flowchart schematically illustrating a process flow for executing a web application in response to a client request using the server architecture of FIG. 2.

FIGS. 4 and 5 are wire frame illustrations showing one embodiment of a development and control interface which may be used to develop web applications using the server architecture of FIG. 2.

FIG. 6 is a flowchart schematically illustrating a data flow for controlling a web application and other resources using the server architecture of FIG. 2.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration satisfying the functional and interface requirements herein described may be suitable for implementing the system and method of the present embodiments.

The present teachings address many of the deficiencies in the prior art by providing a web application server architecture in which an interactive scripting language, development environment and operating-system-like services are embedded. According to one embodiment, an architecture for a web application server includes a server engine installed in an operating system of a computing device, and a server shell installed in the server engine. The server shell may include: a resource management layer for configuring and naming resources and for providing an interface to the resources; a shell services layer for providing application script development tools; a scripting language layer providing a programming language for creating web applications and for accessing external data; and a components layer for providing predefined functionality.

Traditionally, a shell is software that provides an interface for users of an operating system. However, the term shell can also be applied to applications and may include software that is “built around” a particular software component. The name “shell” originates from shells being an outer layer of interface between the user and the internals of the operating system (the “kernel”). Shells may implement command-line and graphical interfaces. For example, in Unix®-like systems, the telnet program has a number of commands for controlling a link to a remote computer system.

The present teachings provide a shell to interact with a web application server to access web application server resources (e.g., threads, sessions, database interfaces, etc.). This allows for robust control of high-level functionality (versus, e.g., typical command-line shell control of low-level operating system functionality, etc.). In addition, the interface for interacting with the web application server may be provided using a web browser (versus, e.g., shell terminal window, etc.). However, other interfaces may be provided for the “shell”, including mobile applications (e.g., smart phones, tablets, etc.), FTP consoles, etc., and the present teachings are not limited to any particular embodiment disclosed herein. The shell itself may be a web application installed on the web application server. Use of a shell makes the system more secure because it is running directly on the web server (e.g., versus using development tools on a remote client computer).

Using the architecture according to the present teachings, a user may easily administer a web application server (generically, a “web server”). For example, a user may access the shell to monitor the allocation of resources, view data, and create logs on the server, although not limited thereto. This architecture may include a user interface for developing and controlling a web application. The interface may include: a command prompt section for receiving a command entered by a user; a resource explorer section for facilitating viewing, searching, and operating on the resources by the user; and an editing section for facilitating editing of data by the user.

A scripting language may provide for high-level control of resources (e.g., components, etc.) on a web application server. In one embodiment, several languages may be supported (e.g., PERL, Python, etc.). A scripting language can be used to compactly and interactively process and display data. This makes web application development and management faster and easier by providing language features such as, although not limited to, the following:
Command-line interactivity—snippets of code can be run interactively for discovery and debugging;
Command history—previously entered (or common) commands are shown and may be easily selected;
Command auto complete for command values and values such as resources in paths, etc.;
Data piping syntax—natural data passing syntax (e.g., similar to Unix® streams);
Object oriented features—access to object beans and methods and actions organized into packages;
String interpolation and templating—built in ability to insert dynamic data into fixed strings;
Web-aware actions—actions default to return data in a format that can be rendered by a web browser with options to render in almost any format; and
External resources organized into a path-oriented structure—databases, files systems, caches and other resources can be mounted and unmounted as needed in an organized way.

In this way, the scripting language can perform a broad assortment of functionality using a command structure:

```
Action based commands in the form <Verb> <Noun> with positional
or named
-<Option>=<Value> options:
echo ‘To be or not to be.’;
log -level=error ‘Parameter error’;
Assignment and variable access:
total = (2 + 7 + 13);
answer = (total + 20);
Hash (associative array) and list (array) data structures:
user = [
      uid: 123,
      name: ‘James Glossing’,
      email: ‘james@glossing.com’
];
primes = [1,2,3,5,7,11];
Path based resource mappings to provide consistent access to external data
such as JDBC databases:
mount /services/db/test ‘jdbc:h2:tcp://localhost:1234/dbtest’;
set /services/db/test/User/123 (user);
get /services/db/test/tables/User/123;
Pipe data from action to action and string interpolation for double-quoted
strings:
(primes) | sub 0 3 | sum | echo “Sum of first 3 primes: (data)”;
Data manipulation components, data redirect to variables and
object oriented features:
(user.name) | split -separator=’ ‘ >names;
user.first = (names[0]);
user.last = (names[1]);
Web-aware parsing and formatting components:
      get /home/test.csv | parse csv | format html table;
```

It is to be appreciated that the aforementioned is exemplary in nature and not limiting. One skilled in the art would appreciate the many different functions that may be provided by the present teachings, which are not limited to any particular embodiment disclosed herein.

The present embodiments outline, rather broadly, preferred features so that those skilled in the art may better understand the present teachings. While additional features will be described hereinafter, those skilled in the art should appreciate that they can readily use the present teachings as a basis for designing or modifying other structures for carrying out the same purposes and that such other structures do not depart from the spirit and scope of the disclosure in its broadest form.

For example, while the present teachings relate to web services, it will be appreciated that the disclosure applies to other services such as file transfer, data manipulation, data storage, transaction routing, etc., which may be described generally as “networked services.”

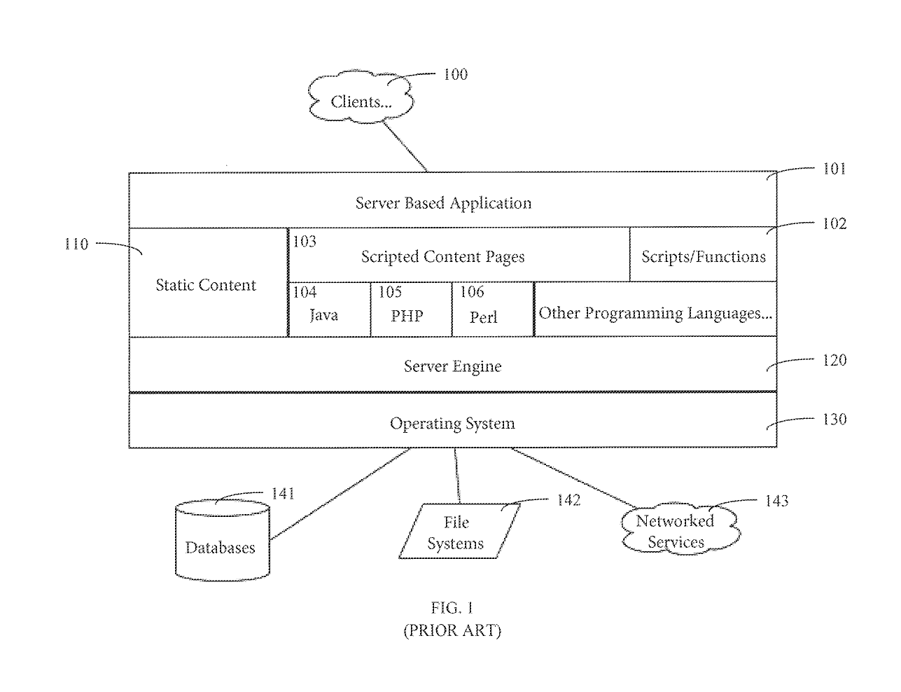

Referring now to FIG. 1, shown is a schematic illustration of a typical web server architecture in the prior art. This application server architecture includes server based applications 101 that are built with scripts 102 and/or scripted pages 103 using programming languages 104, 105, 106 (e.g., Java PHP, Perl, PHP, etc.). The programming languages 104, 105, 106 run inside a server engine 120 which is installed in an operating system 130 (e.g., Linux®, Windows®, etc.). The server based applications 101 access resources such as databases 141, file systems 142, and other networked services 143 through facilities provided by the operating system 130.

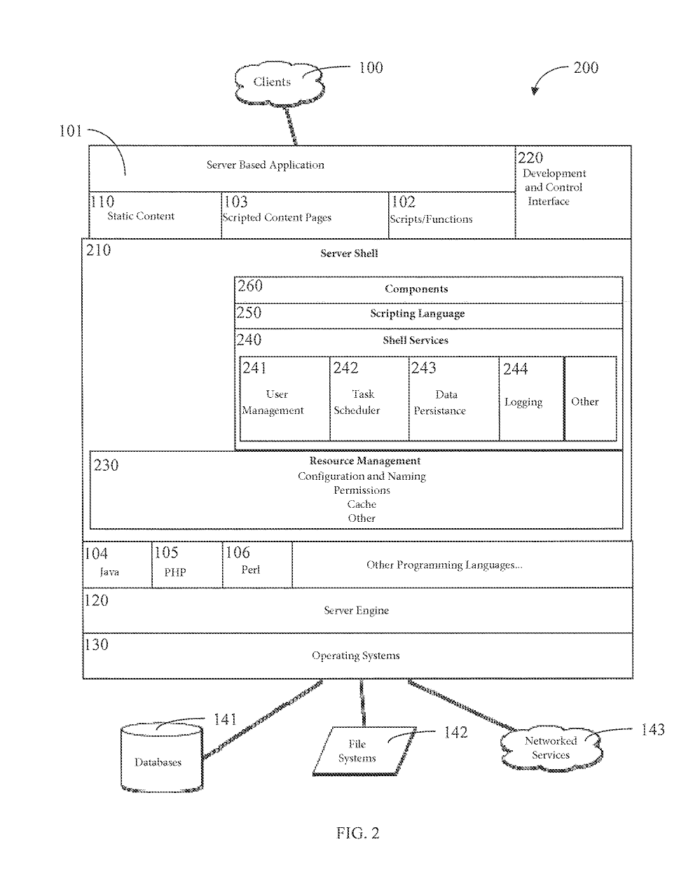

Referring now to FIG. 2, shown is a schematic illustration of one embodiment of a web server architecture 200 according to the present teachings. This presents the new concept of embedding a shell interface for an interactive scripting language, development environment, and operating-system-like services within a web server. Among other advantages, this makes web application development and deployment faster, easier and more secure.

As shown, the new application server architecture 200 adds a server shell layer 210 embedded in the web server between the server engine 120 and the application scripts 102, 103, although not limited thereto. It also adds a built-in development and control interface 220 (generically, “interface”) used to create applications and control the underlying configuration and deployments.

The server shell 210 may be composed of several layers. A resource management layer 230 may provide a common interface to external resources such as databases 141, file systems 142, and other networked services 143. When a resource is configured (or “mounted”, etc.), it may be assigned a name such as “/order_database”. Subresources underneath that resource may be uniquely named in a hierarchy such as “/order database/tables” and “/order_database/tables/table_uno”, although not limited thereto.

In one embodiment, resources also have defined permissions so that certain users or requestors may only read, write or have no access at all. There may also be facilities to cache or do other operations with the resources depending on how they are configured. In general, resources may be configured to add a variety of features to the application (e.g., caching, security features, etc.) and the present teachings are not limited to any particular embodiment disclosed herein.

Users may log in to access the server shell and permitted functionality (according to their assigned permissions). In one embodiment, the server shell interface is provided through web pages, and the user may log into a website in order to access the server shell, using log in credentials (e.g., username, password, etc.).

The static content 110, scripted content pages 103, and scripts/functions 102 may be processed by the server engine 120 and may or may not use the resource configurations defined in the shell services 240, depending on how the server is configured. On top of the resources, shell services 240 may provide tools to be used in an application script development. The shell services may include user management 241, task scheduling 242, data persistence 243, logging 244, as well as additional services. One skilled in the art would appreciate that any number of additional services may be used with the present teachings, which are not limited to any particular embodiment disclosed herein.

The scripting language 250 is a programming language used to manipulate data to create applications. It may be used interactively through the development and control interface 220 or non-interactively in scripts, although not limited thereto. It may access external data through the resource management layer 230, which allows an application server to be set up with a “sandbox” to control access to resources for any user or group of users, although not limited thereto.

Scripts may be combined into components 260 to provide more complex services to the application. A component 260 may be viewed as an encapsulation of a specific functionality inside the shell 210 (e.g., searching a message feed based on a keyword, making a chart from a collection of data, etc.).

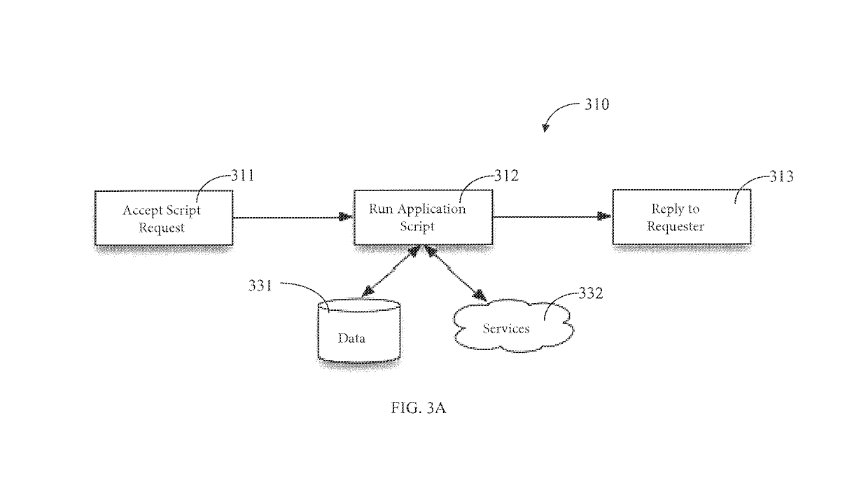

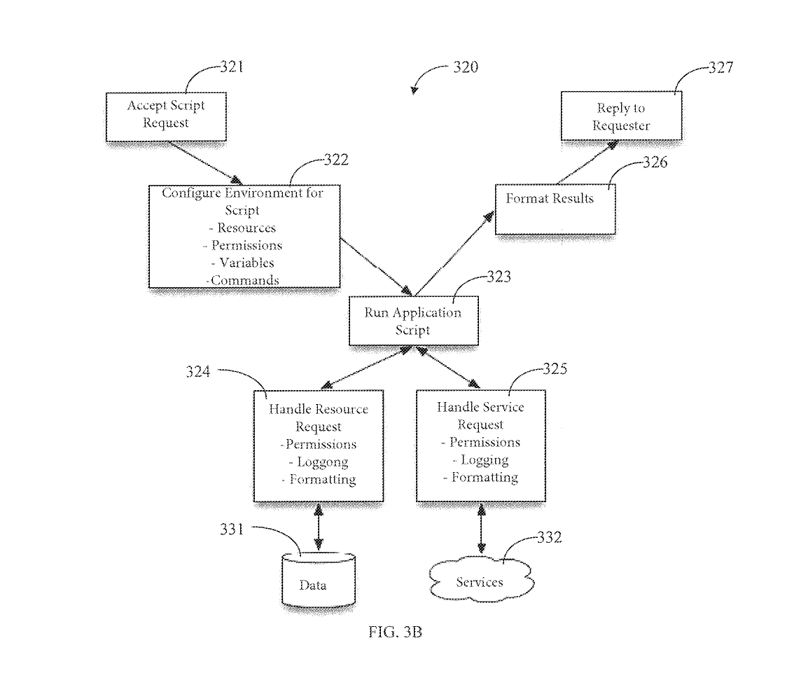

Referring now to FIG. 3A, shown is a flowchart schematically illustrating a process flow for executing a web application in response to a client request using the server architecture of FIG. 1. The typical process flow using the prior art architecture of FIG. 1 consists of the server engine accepting a script request 311 from a requester (such as a web client, automatic trigger, etc.). The server engine then runs the application script 312, which may read from and/or write to external data stores 331 and services 332. The server engine then sends any output from the Application Script with a reply to the requester 313.

Referring now to FIG. 3B, shown is a flowchart schematically illustrating a process flow for executing a web application in response to a client request using the server architecture of FIG. 2. Here, the process flow differs from the typical process flow of FIG. 3A because the present teachings add a “shell” layer around the script when it runs, which means that processing may occur before, after and during the script runtime.

As shown, a script request is accepted from a requester 321. Before the script runs, the script environment may be set up 332. The environment may comprise the resources, variables and commands that the script has available for processing. The environment components may be loaded or configured from data storage and checked against the user permissions, although not limited thereto.

When the script runs 323, data input and output may be handled by resource 324 and service 325 handlers. These may check permissions, format the data, and log the access, although not limited thereto. Once the script is complete, the output may be formatted 326 for the requester by the shell service and sent to the requester 327.

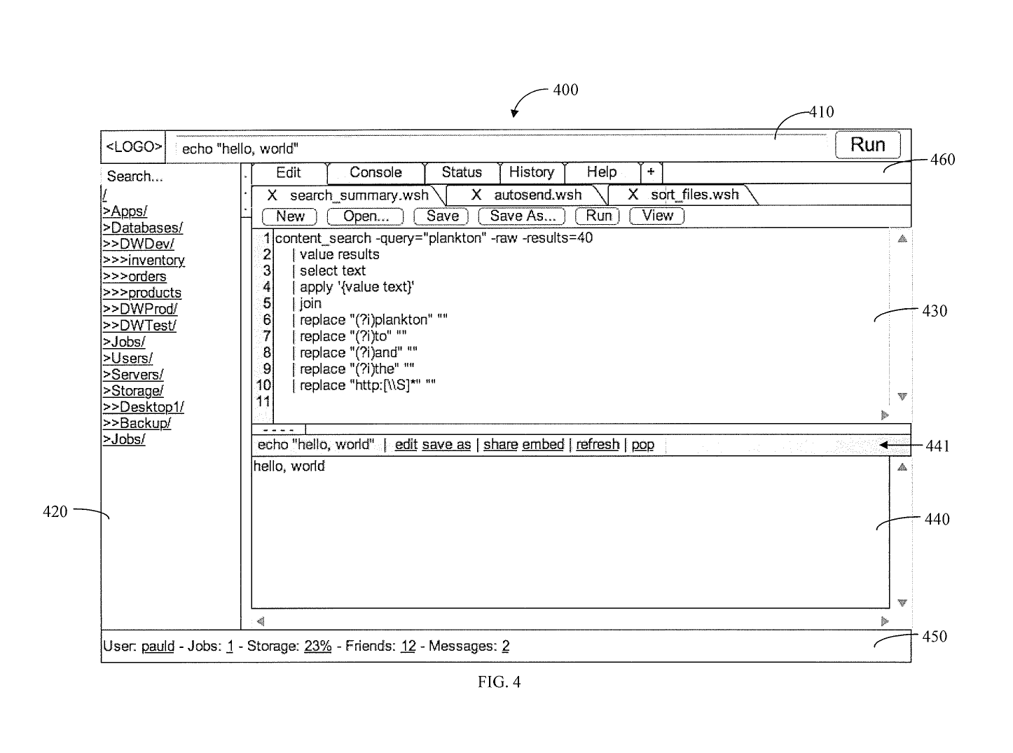

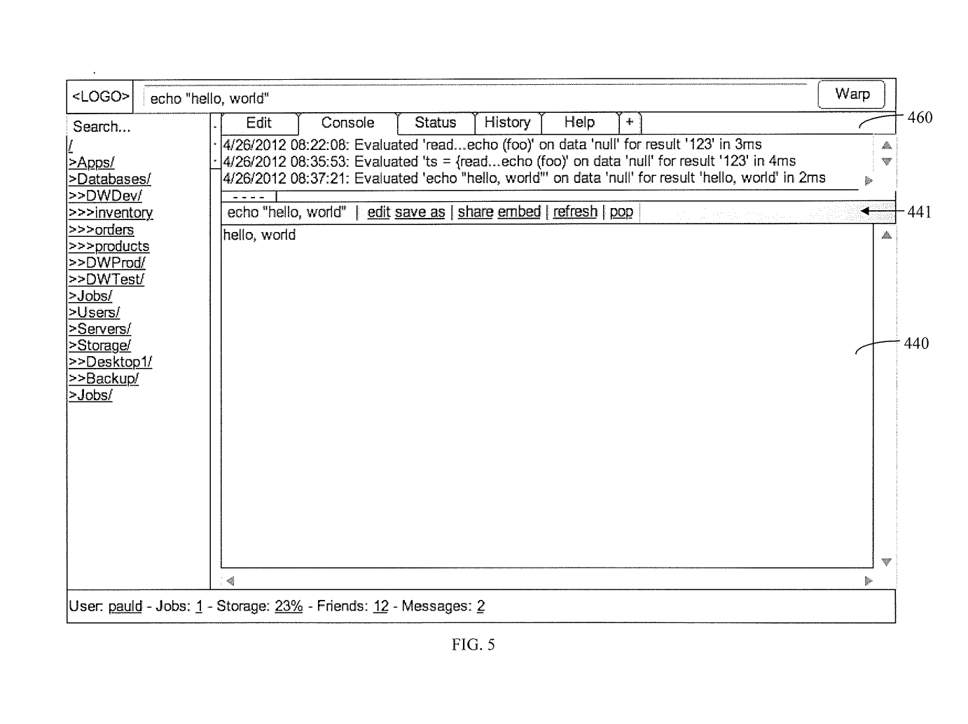

Referring now to FIGS. 4 and 5, shown are wire frame illustrations of one embodiment of a development and control interface 400 which may be used to develop web applications using the server architecture of FIG. 2. The development and control interface may 400 provide a graphical user interface for human users to interact with the server shell, and may be used to develop and manage applications. The interface may also be used to set up, organize, and interface content management systems, although not limited thereto. A user may also monitor and manage application(s) using visual components including a status section 450, and a selector section 460.

As shown in FIG. 4, selecting an “Edit” tab may cause the editor section 430 to be displayed. The development and control interface 400 may provide features such as a command prompt 410 where users can enter scripting language (or other code, etc.) and immediately see the results of execution. This way, a user can interactively (e.g., in real-time) run script on the server. In conjunction with an editor section 430, a user may edit code, images or other data by manipulating these objects (e.g., a web page, etc.) directly on the server. There may be display section 440 that includes display portals 441 to let the user view and manipulate the results of running scripts.

The selector section 460 may have several tabs for activating various components. For example, there may also be a resource explorer 420 where users may interactively view, search and operate on resources. In this way, using the editor tab a user may create and edit files (e.g., web pages, etc.) directly on the server.

FIG. 5 illustrates the interface with the “console” tab selected. This may provide real-time status and tracing of scripts run in the command prompt. Other visual components e.g. dashboard, branding, etc. may be included.

The command prompt 410 and editor 430 components may have facilities for auto-completion. In this way, when a user is editing scripting or other code, they may be prompted to enter or select additional text given the context of what they are editing and/or what they or others have entered in the past, although not limited thereto.

The development and control Interface facilitates development of applications over the web. Thus, there may be no need for a developer to install any software. Depending on the type of scripting language, the interface permits the user to make powerful statements in the command prompt section. For example, the user may enter scripting commands that invoke performance of multiple tasks. Creating dynamic web pages using scripting allows web applications to be developed rapidly by tying components together, using only a few lines of code. Accordingly, a user may interactively create a website without having to download software.

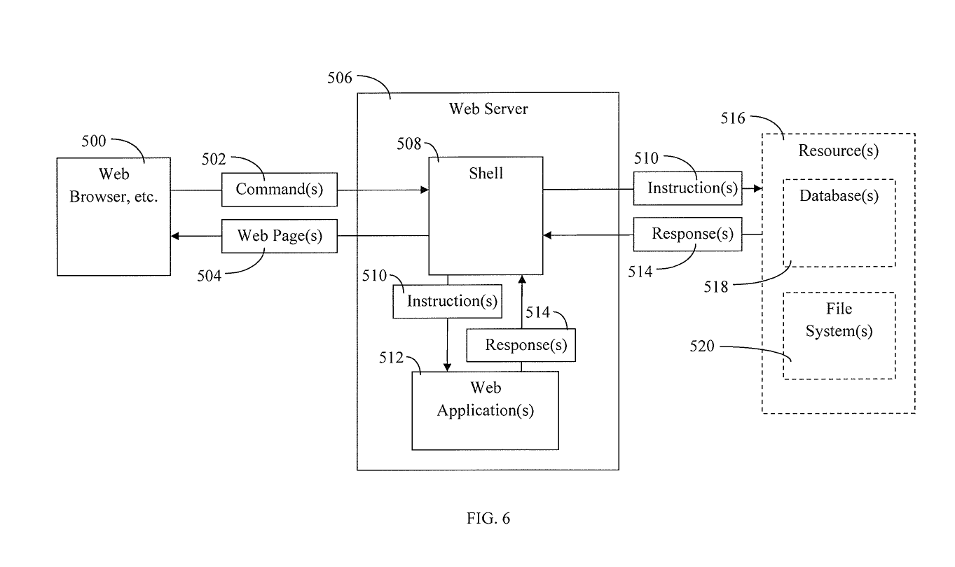

Referring now to FIG. 6, shown is a flowchart schematically illustrating a data flow for controlling a web application and other resources using the server architecture of FIG. 2. Using a traditional web browser 500, a user may access the shell on the web server. Although a web browser is shown, it is to be appreciated that any number of different technologies may be used to access the shell interface (e.g., FTP, mobile application, etc.), and the present teachings are not limited any particular embodiment disclosed herein.

Using the development and control interface 400 (shown in FIGS. 4 and 5), which is provided through the web browser 500, the user may issue commands 502 to the shell 508 running on a web server 506. The shell 508 may then translate these commands into instructions 510 for other web applications 512 and resources 516, 518, 520. The web applications 512 and resources 516, 518, 520 may provide response(s) 514 to the shell 508, which the shell may then format (e.g., into HTML) and return as a web page 504 to the web browser 500.

As discussed above, the web server architecture may be deployed as a web application. An installer script and related classes, etc., may be installed on the web server to provide the functionality discussed herein. A user may access this functionality through a default web address, e.g., www.mysite.com/warp, etc., to access the development and control interface 400 (shown in FIGS. 4 and 5).

In another embodiment, the web server architecture and interface may be offered as a service. In particular, the server shell as described above may be offered as a cloud service. In this way, the system may provide a single source for a hosted web service and management (e.g., through the server shell), without the need for users to download any software.

It will be appreciated that a server architecture according to the disclosure may be used to develop a wide variety of enterprise applications, including business intelligence systems, dashboards, and analytical tools, although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A web application server system, comprising:
a web server having an operating system and a server engine;
at least one server based application executing on the web server and using the server engine;
an interface having a graphical user interface receiving at least one command; and
a server shell executing on the web server, the server shell receiving the at least one command from the interface, sending the at least one command to the at least one server application, receiving at least one response from the at least one server application in response to the at least one command, and sending the at least one response to the interface, the interface displaying the at least one response.

2. The system of claim 1 wherein the server shell comprises:
a resource management layer providing an interface to resources and adapted to configure and name the resources;
a shell services layer providing application script development tools;
a scripting language layer providing a programming language adapted to create web applications and access external data; and
a components layer providing predefined functionality;
wherein the layers are provided through the interface.

3. The system of claim 1 wherein the server shell comprises a scripting language library, the at least one command comprises scripting language according to the scripting language library, and the server shell translates the at least one command before sending it to the at least one server application.

4. The system of claim 1 wherein the server shell translates the at least one command before sending it to the at least one server application.

5. The system of claim 1 wherein the server shell translates the at least one response before sending it to the interface.

6. The system of claim 1 wherein the interface comprises at least one web page.

7. The system of claim 1 wherein the interface comprises an application executing on a mobile device in electronic communication with the web server.

8. The system of claim 1 wherein the server shell comprises a command prompt provided through the interface.

9. The system of claim 1 wherein the server shell comprises an editor provided through the interface and adapted to edit and create files on the server.

10. The system of claim 1 wherein the server shell comprises a resource explorer provided through the interface and adapted to view, search, and operate on resources.

11. The system of claim 1 further comprising a database server and/or file server in electronic communication with the server shell,
wherein the server shell receives at least one further command from the interface, sends the at least one further command to the database server and/or file server, receives at least one further response from the database server and/or file server in response to the at least one further command, and sends the at least one further response to the interface, the interface displaying the at least one further response.

12. The system of claim 1 wherein the server shell comprises a web application on the web server.

13. The system of claim 1 wherein the server shell provides interactive script execution.

14. The system of claim 1 further comprising a storage having permissions, wherein functionality provided through the interface is based on the permissions.

15. The system of claim 1 wherein the interface comprises auto complete suggestions for data entered through the interface.

16. A web application server system, comprising:
a web server having an operating system and a server engine;
at least one server based application executing on the web server and using the server engine;
an interface having a graphical user interface receiving at least one command; and
a server shell executing on the web server, the server shell receiving the at least one command from the interface, sending the at least one command to the at least one server application, receiving at least one response from the at least one server application in response to the at least one command, and sending the at least one response to the interface, the interface displaying the at least one response;
wherein the server shell comprises an editor provided through the interface and adapted to edit and create files on the server;
the server shell provides interactive script execution; and
the interface comprises at least one web page.

17. A method of managing a web application server system, comprising:
providing a web server having an operating system, a server engine, and at least one server based application using the server engine;
providing an interface having a graphical user interface;
receiving, with the interface, at least one command;
providing a server shell executing on the web server;
receiving, with the server shell, the at least one command from the interface;
sending, with the server shell, the at least one command to the at least one server application;
receiving, with the server shell, at least one response from the at least one server application in response to the at least one command;
sending, with the server shell, the at least one response to the interface; and
displaying the at least one response through the interface;
wherein the server shell provides interactive script execution.

18. The method of claim 17 wherein the at least one command comprises commands for monitoring the web server.

19. The method of claim 17 wherein the at least one command comprises commands for creating a web application.

20. The method of claim 17 wherein the at least one command comprises commands for managing resources on the web server.
